(19) United States
(12) Patent Application Publication
(10) Pub. No.: US 2025/0079979 A1
(43) Pub. Date: Mar. 6, 2025

(54) ELECTRICAL SYSTEM FOR A MOTOR VEHICLE

(71) Applicant: VITESCO TECHNOLOGIES GmbH, Regensburg (DE)

(72) Inventor: Philippe BOISSIERE, Toulouse (FR)

(21) Appl. No.: 18/293,252

(22) PCT Filed: Sep. 12, 2022
(86) PCT No.: PCT/EP2022/075271

§ 371 Date: Jan. 29, 2024

(30) Foreign Application Priority Data
Sep. 15, 2021 (FR) FR2109665

(51) Int. Cl. H02M 3/00; H02M 1/00; H02M 1/42; H02M 3/335

(52) U.S. Cl. CPC H02M 3/01; H02M 1/007; H02M 1/4208; H02M 3/33573; H02M 3/33584

(57) ABSTRACT

An electric system for a motor vehicle with at least one supply battery includes an electric charger for charging a battery from an external electric grid, the charger including a corrector, a converter including first and second H-bridges and characterized by a frequency referred to as the “resonant” frequency, and a link capacitor connected between the corrector and the converter, the microcontroller being configured to, when the battery is charging, if the frequency of the control signal is equal to the upper bound of the resonant range: control the conversion ratio of the power factor corrector so as to decrease the voltage across the terminals of the link capacitor, so as to make the voltage equal to 95% of the average operating voltage of the link capacitor; and set the frequency of the control signal so that it is lower than the lower bound of the resonant range.

### TECHNICAL FIELD

The invention relates to the field of electric or hybrid vehicles and more precisely to electric systems for electric or hybrid vehicles comprising an on-board charger and a microcontroller, and to the method implemented by said electric system.

### PRIOR ART

In a known manner, an electric or hybrid vehicle comprises a battery able to supply electric power to electric devices that are installed in the vehicle, or connected to the vehicle, and to the electric machine of the vehicle.

The vehicle also comprises an on-board charger, better known as the OBC (acronym of On-Board Charger), connected to the battery. The on-board charger allows the DC voltage supplied by the battery to be converted into an AC voltage, in order to power various electric devices. Moreover, the on-board charger also allows an AC voltage to be converted into a DC voltage in order to recharge the battery.

An on-board charger in particular comprises a power factor corrector (PFC), a DC-DC current converter, a link capacitor connecting the power factor corrector and the current converter, and a microcontroller able to control the power factor corrector.

The current converter in particular comprises two H-bridges, comprising a plurality of switches.

For example, in the case where the battery is being charged, the power factor corrector is the element of the on-board charger that converts an AC voltage, supplied by an electric grid external to the vehicle, into a DC voltage of between 300 and 800 V. The link capacitor allows residual oscillations in the DC voltage supplied by the power factor corrector to be eliminated. The DC-DC current converter is then able to convert the DC voltage smoothed by the capacitor to another DC voltage value, comprised between about 200 and 300 V, that is able to charge the battery.

In particular, the microcontroller is able to control the switches of the current converter open and closed in order to modify the gain thereof. To do this, the microcontroller transmits to each switch a control signal characterized by a frequency.

However, when the frequency of the control signal approaches the resonant frequency of the converter, a large undesired increase in the gain of the converter or problems with charger instability that may cause current oscillations may occur. Thus, on the one hand, the gain setpoint is not respected. On the other hand, the oscillations may potentially degrade the various elements of the on-board charger.

In order to remedy this drawback, only frequency values lower than the resonant frequency are used when charging the battery. To this end, it is necessary to considerably increase the value of the input voltage of the converter, for example to increase the input voltage from 375 V to 800 V. To do this, it is necessary to modify many components of the on-board charger.

In particular, the link capacitor must be configured to withstand high voltages, commonly of above 450 V and up to 800 V. However, the more the capacitor is configured to withstand high voltages, the more expensive and bulkier it becomes. For the same reasons, it may also be necessary to modify the transistors of the power factor corrector so that they are able to withstand voltages greater than 650 V.

A solution is therefore required to overcome these drawbacks at least in part.

### SUMMARY OF THE INVENTION

To this end, the invention relates to an electric system for a motor vehicle, the vehicle comprising at least one supply battery, the electric system comprising a microcontroller and an electric charger that is intended to be connected, on the one hand, to said battery and, on the other hand, to an electric grid external to the vehicle supplying an AC voltage, the charger being able to charge the battery from an external electric grid, the charger comprising:
a power factor corrector, which is able to convert an AC voltage into a DC voltage, the conversion being characterized by a conversion ratio, and which is electrically connected to the electric grid,
a DC-DC voltage converter connected between the power factor corrector and the battery and able to convert a DC voltage into another DC voltage, said DC-DC voltage converter comprising a first H-bridge, and a second H-bridge, each H-bridge comprising four switches, a first switch being connected between a high point and a midpoint, a second switch being connected between the midpoint and a low point, a third switch being connected between the high point and a second midpoint and a fourth switch being connected between the second midpoint and the low point, the voltage converter also comprising a transformer electrically connecting the first H-bridge and the second H-bridge,
   the converter being characterized by a frequency, referred to as the “resonant” frequency, that is the frequency at which the voltage and current across the terminals of the converter are in phase, and by a resonant range the lower bound of which is 0.9 times the resonant frequency and the upper bound of which is 1.1 times the resonant frequency, and a link capacitor, which is connected between the power factor corrector and the DC-DC voltage converter, and which is able to attenuate residual oscillations in the voltage supplied between the power factor corrector and the DC-DC voltage converter, the link capacitor being characterized by an average operating voltage,
   the microcontroller is configured to:
a) control each switch of the first bridge and of the second bridge of the DC-DC voltage converter open and closed by transmitting a control signal to each switch, each control signal being characterized by a frequency,
b) control the conversion ratio of the corrector,
c) when the battery is charging, if the frequency of the control signal is equal to the upper bound of the resonant range:
   i) control the conversion ratio of the power factor corrector so as to decrease the voltage across the terminals of the link capacitor, so as to make said voltage equal to 95% of the average operating voltage of said link capacitor,
   ii) set the frequency of each control signal so that it is lower than the lower bound of the resonant range.

The gain of the converter is set to a predetermined value in order to recharge the battery. Since the voltage across the terminals of the link capacitor is decreased, the converter must increase the voltage it supplies, to obtain a set gain. Therefore the converter must increase its own gain. To do this, the converter decreases the frequency of the control signal. Thus, the frequency of the control signal changes directly from a value higher than the resonant range to a value lower than the resonant range. Thus, the frequency of the control signal imposed by the microcontroller is never comprised in the resonant range and is therefore always different from the resonant frequency, thus preventing oscillating currents from propagating through the components of the charger and therefore probable degradation of these components. In addition, the microcontroller may now use frequencies lower than the resonant range.

Also preferably, the charger is intended to be connected, on the one hand, to said battery and, on the other hand, to devices, the charger being able to allow the battery to power said devices, the converter being bidirectional and the power factor corrector, which is electrically connected to the devices, being able to convert a DC voltage into an AC voltage, the microcontroller being configured to, when the battery is discharging and if the frequency of the control signal is equal to the lower bound of the resonant range:
control the conversion ratio of the power factor corrector so as to increase the voltage across the terminals of the link capacitor, so as to make said voltage equal to 105% of the average operating voltage of said link capacitor,
set the frequency of each control signal so that it is higher than the upper bound of the resonant range.

The gain is set to a predetermined value in order to power devices. Since the voltage across the terminals of the link capacitor is increased, the converter must decrease the voltage it supplies, to obtain a set gain. Therefore the converter must decrease its own gain. To do this, the converter increases the frequency of the control signal. Thus, the frequency of the control signal changes directly from a value lower than the resonant range to a value higher than the resonant range. Thus, the frequency of the control signal imposed by the microcontroller is never comprised in the resonant range and is therefore always different from the resonant frequency, thus preventing oscillating currents from propagating through the components of the charger and therefore probable degradation of these components. In addition, the microcontroller may now use frequencies higher than the resonant range.

Advantageously:
the transformer of the converter comprises a primary winding and a secondary winding, each winding comprising a first terminal and a second terminal,
the converter comprises a first resonant circuit comprising a resonant capacitor and a coil connected in series, the resonant capacitor of the first resonant circuit being electrically connected to the first midpoint of the first bridge, and the coil of the first resonant circuit being electrically connected to the first terminal of the primary winding of the transformer.

Advantageously, the converter comprises an additional coil, connected in parallel with the primary winding of the transformer.

Also preferably, the converter comprises a second resonant circuit comprising a resonant capacitor and a coil connected in series, the resonant capacitor of the second resonant circuit being electrically connected to the first midpoint of the second bridge, and the coil of the second resonant circuit being electrically connected to the first terminal of the secondary winding of the transformer.

Also preferably, each switch is a MOSFET or bipolar transistor.

The invention also relates to a motor vehicle comprising at least one battery and at least one electric system such as described above.

The invention also relates to a method for controlling the control signal of a motor-vehicle electronic-system converter such as described above, when the battery is charging, if the frequency of the control signal is equal to the upper bound of the resonant range, the method comprises steps of:
controlling the conversion ratio of the power factor corrector so as to decrease the voltage across the terminals of the link capacitor, so as to make said voltage equal to 95% of the average operating voltage of said link capacitor,
setting the frequency of the control signal so that it is lower than the lower bound of the resonant range.

Preferably, when the battery is discharging and if the frequency of the control signal is equal to the lower bound of the resonant range, the method comprises the steps of:
controlling the conversion ratio of the power factor corrector so as to increase the voltage across the terminals of the link capacitor, so as to make said voltage equal to 105% of the average operating voltage of said link capacitor,
setting the frequency of the control signal so that it is higher than the upper bound of the resonant range.

The invention also relates to a computer program product that is noteworthy in that it comprises a set of program code instructions, which, when they are executed by one or more processors, configure the one or more processors to implement a method as described above.

### DESCRIPTION OF THE DRAWINGS

Other features and advantages of the invention will become more clearly apparent on reading the following description. This description is purely illustrative and should be read with reference to the appended drawings, in which:

FIG. 1 schematically illustrates the electric system according to the invention;

FIG. 2 shows the electronic circuit of unidirectional charger converter of the electric system in FIG. 1;

FIG. 3 shows the electronic circuit of a bidirectional charger converter of the electric system in FIG. 1;

FIG. 4 schematically shows the method according to the invention;

FIG. 5 illustrates the variation in the voltage across the terminals of the battery as a function of the frequency of the control signal transmitted by the microcontroller, for a voltage across the terminals of the link capacitor of 380 V and for a voltage across the terminals of the link capacitor of 420 V.

### DESCRIPTION OF THE EMBODIMENTS

### Vehicle

An embodiment of the vehicle according to the invention will now be described. The vehicle is in particular an electric or hybrid vehicle and comprises an electric machine able to convert electric energy into mechanical energy in order to rotate the wheels of the vehicle. The electric machine therefore in particular is the electric propulsion machine of the vehicle.

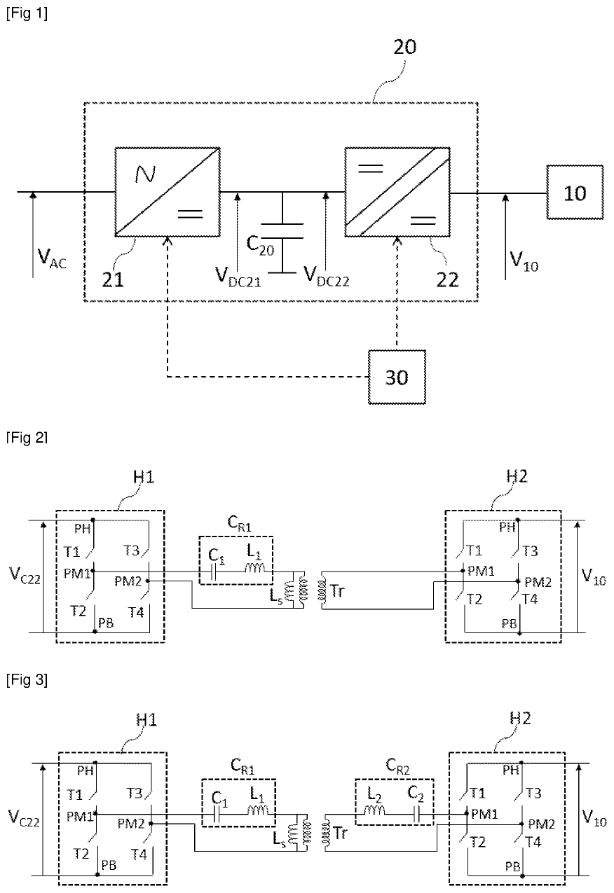

With reference to FIG. 1, the vehicle comprises a supply battery 10 and an electric system comprising an on-board charger 20 and a microcontroller 30.

The supply battery 10 is in particular able to operate in a discharging mode, in which the battery 10 supplies power to devices of the vehicle or to the electric machine, i.e. the electric propulsion machine of the vehicle, or to other devices external to the vehicles that have been connected to the battery 10.

The battery 10 is also able to operate in a charging mode, in which the battery 10 is able to be charged using electric power supplied by an electric grid external to the vehicle and electrically connected to the battery 10.

For example, the voltage of the battery 10 may be 300 V or 800 V.

The charger 20, better known as the OBC (acronym of On-Board Charger), is connected, on the one hand, to the battery 10 and, on the other hand, to at least one device that is installed in the vehicle or outside the vehicle, or to an electric grid in particular external to the vehicle and able to supply an AC voltage.

The charger 20 may be unidirectional. In other words, when the charger 20 is connected to the electric grid and the battery 10 is operating in charging mode, the charger 20 is in particular able to convert the AC voltage supplied by the electric grid into a DC voltage able to charge the battery 10.

The charger 20 may also be what is referred to as “bidirectional”. In other words, when a device is connected to the charger 20, the battery 10 operates in discharging mode, and the charger 20 is also able to convert the DC voltage supplied by the battery 10 into an AC voltage able to power the device.

More specifically, the charger 20 comprises a power factor corrector 21 and a DC-DC voltage converter 22 and a link capacitor C₂₀. The converter 22 is electrically connected to the corrector 21 via a wired link. In addition, the link capacitor C₂₀ is connected as a branch off the wired link connecting the corrector 21 and the converter 22.

In addition, the converter 22 is configured to be electrically connected to the battery 10 and the power factor corrector 21 is configured to be electrically connected to a device of the vehicle or outside the vehicle or to the electric grid.

Still with reference to FIG. 1, the power factor corrector 21 is able to convert an AC voltage V_{AC} into a DC voltage V_{DC21}, and vice versa.

The corrector 21 is characterized by a first conversion ratio between the AC voltage V_{AC} and the DC voltage V_{DC21}.

The DC-DC voltage converter 22 is able to convert a DC voltage V_{DC22} into another DC voltage V₁₀.

When the charger 20 is unidirectional, then the converter 20 is able to convert the DC voltage V_{DC22} into the DC voltage V₁₀ in order to charge the battery 10.

When the charger 20 is bidirectional, then when the battery 10 is operating in discharging mode, the converter 22 is also able to convert the DC voltage V₁₀ supplied by the battery 10 into the DC voltage V_{DC22}.

The converter 22 is characterized by a second conversion ratio, in other words by a gain, between the DC voltage V_{DC22} and the DC voltage V₁₀ (or vice versa). The value of the gain is variable and in particular defined in an interval comprised between 0.4 and 1.3.

The link capacitor C₂₀ is able to attenuate residual oscillations in the DC voltage supplied between the power factor corrector 21 and the DC-DC voltage converter 22.

For example, when the battery 10 is operating in charging mode, the corrector 21 is connected to an electric grid. Thus, the corrector 21 converts the AC voltage supplied by the electric grid into a DC voltage V_{DC21} of substantially 400 V. However, the DC voltage V_{DC21} has an AC portion or, in other words, the DC voltage V_{DC21} contains residual oscillations, for example of plus or minus 30 V. The link capacitor C₂₀ allows the residual oscillations in the DC voltage V_{DC21} to be eliminated. Lastly, the converter 22 converts the DC voltage V_{DC21} without residual oscillations into a DC voltage V₁₀ suitable for recharging the battery 10, for example a DC voltage between 220 V and 465 V.

Conversely, when the battery 10 is operating in discharging mode and the charger 20 is bidirectional then this means that the corrector 21 is connected to an electronic device to be powered. The converter 22 converts the DC voltage V₁₀ supplied by the battery 10 into another DC voltage V_{DC22}, for example one about equal to 400 V. The DC voltage V_{DC22} supplied by the converter 22 has an AC portion or, in other words, the DC voltage V_{DC22} contains residual oscillations, for example of plus or minus 30 V. The link capacitor C₂₀ allows the residual oscillations in the DC voltage V_{DC22} to be eliminated. Lastly, the corrector 21 converts the DC voltage V_{DC22} without oscillations of substantially 400 V into an AC voltage able to power the device connected to said corrector 21.

The link capacitor C₂₀ is characterized by an average operating voltage. In other words, in the example presented above, the average operating voltage is for example 400 V.

The detailed electronic structure of the converter 22 will now be described. The converter 22 is a unidirectional CLL resonant DC-DC voltage converter, or a bidirectional CLLLC resonant DC-DC voltage converter.

In FIG. 2, the converter 22 is a unidirectional CLL resonant DC-DC voltage converter and comprises a transformer Tr, a first H-bridge, designated H1 in FIG. 2, a second H-bridge, designated H2 in FIG. 2, and a first resonant circuit CR1.

The transformer Tr comprises a primary winding and a secondary winding, each winding comprising a first terminal and a second terminal.

Each bridge H1, H2 comprises four switches, a first switch T1 being connected between a high point PH and a midpoint PM1, a second switch T2 being connected between the midpoint PM1 and a low point PB, a third switch T3 being connected between the high point PH and a second midpoint PM2 and a fourth switch T4 being connected between the second midpoint PM2 and the low point PB.

The switches may be any type of switch, and in particular MOSFETs or bipolar transistors.

The first resonant circuit CR1 comprises a resonant capacitor C1 and a coil L1 connected in series.

The resonant capacitor C1 of the first resonant circuit CR1 is electrically connected to the first midpoint PM1 of the first bridge H1, and the coil L1 of the first resonant circuit CR1 is electrically connected to the first terminal of the primary winding of the transformer Tr.

The second terminal of the primary winding of the transformer Tr is electrically connected to the second midpoint PM2 of the first bridge H1.

The first terminal of the secondary winding of the transformer Tr is electrically connected to the first midpoint PM1 of the second bridge H2. The second terminal of the secondary winding of the transformer Tr is electrically connected to the second midpoint PM2 of the second bridge H2.

For example, the transformer Tr is able to apply, across the terminals of the secondary winding, an output voltage equal to the voltage applied to the first winding. This ratio of 1 between the output voltage and the voltage applied to the first winding can be modified.

The converter 22 also comprises an additional coil in parallel with the primary winding of the transformer Tr. The additional coil Lₛ may be internal or external to the transformer Tr. When the additional coil is external to the transformer Tr, the converter 22 corresponds to a unidirectional CLL resonant DC-DC voltage converter.

With reference to FIG. 3, when the converter 22 is a bidirectional CLLLC resonant DC-DC voltage converter, then the converter 22 comprises a circuit identical to the circuit corresponding to a unidirectional CLL converter 22, to which a second resonant circuit CR2 is added.

The second resonant circuit CR2 comprises a resonant capacitor C2 and a coil L2 connected in series. The second resonant circuit CR2 is connected between the first midpoint PM1 of the second bridge H2 and the second midpoint PM2 of the second bridge H2.

In other words, the resonant capacitor C2 of the second resonant circuit CR2 is electrically connected to the first midpoint PM1 of the second bridge H2, and the coil L2 of the second resonant circuit CR2 is electrically connected to the first terminal of the secondary winding of the transformer Tr.

The converter 22 is characterized by a resonant frequency, which is the frequency at which the voltage and current across the terminals of the converter 22 are in phase.

The converter 22 is also characterized by a resonant range the lower bound of which is 0.9 times the resonant frequency and the upper bound of which is 1.1 times the resonant frequency. In other words, the resonant range is defined around the resonant frequency.

The microcontroller 30 is able to periodically receive the value of the current across the terminals of the battery 10.

The microcontroller 30 is configured to control the second conversion ratio of the corrector 22. When the microcontroller 30 varies the second conversion ratio, then the voltage across the terminals of the link capacitor C₂₀ also varies.

The microcontroller 30 is also able to control the converter 22 in order to define the second conversion ratio, or in other words the gain, of said converter 22 as a function of the current across the terminals of the battery 10. To do this, the microcontroller 30 is able to control each switch of the first bridge H1 and of the second bridge H2 open and closed. In particular, in the case where the battery 10 is operating in charging mode, the microcontroller 30 controls the first bridge H1. Conversely, when the battery 10 is operating in discharging mode, the microcontroller 30 controls the second bridge H2.

More precisely, the microcontroller 30 is able to control the converter 22 by controlling each switch of the first bridge H1 and of the second bridge H2 open and closed, in particular using a frequency-modulation method. To this end, the microcontroller 30 transmits a control signal to each switch. Each control signal is defined by a periodic square-wave signal, the duty cycle of which is in particular 50%, and by a frequency. The microcontroller 30 is able to modify the frequency of each control signal depending on the gain desired for the converter 22.

The frequency of the control signal is inversely proportional to the gain of the converter 22.

When the battery 10 is operating in charging mode, whether the charger 20 is unidirectional or bidirectional, and if the frequency of the control signal is equal to the upper bound of the resonant range, the microcontroller 30 is configured to:
a. control the conversion ratio of the power factor corrector 21 so as to decrease the voltage across the terminals of the link capacitor C₂₀, so as to make said voltage equal to 95% of the average operating voltage of said link capacitor C₂₀,
b. set the frequency of each control signal so that it is lower than the lower bound of the resonant range.

In this way, the frequency of the control signal is never equal to the resonant frequency or is never comprised in the resonant range. In addition, frequencies lower than the resonant range may be used when charging the battery 10.

When the battery 10 is operating in discharging mode (and when the charger 20 is bidirectional), and if the frequency of the control signal is equal to the lower bound of the resonant range, the microcontroller 30 is configured to:
a. control the conversion ratio of the power factor corrector 21 so as to increase the voltage across the terminals of the link capacitor C₂₀, so as to make said voltage equal to 105% of the average operating voltage of said link capacitor C₂₀,
b. set the frequency of each control signal so that it is higher than the upper bound of the resonant range.

In this way, the frequency of the control signal is never equal to the resonant frequency or is never comprised in the resonant range. In addition, frequencies higher than the resonant range may be used when discharging the battery 10.

The microcontroller 30 comprises a PID regulation function (PID standing for Proportional-Integral-Derivative). When the charger 20 is unidirectional, the microcontroller 30, through its PID regulation function, is able to obtain the value of the DC voltage V₁₀ between the converter 22 and the battery 10 and to receive the voltage setpoint to be applied between the converter 22 and the battery 10. The microcontroller 30 is able to determine whether each measured value corresponds to the received voltage setpoint to be applied between the converter 22 and the battery 10.

When the charger 20 is bidirectional, the microcontroller 30 is also able to obtain the value of the DC voltage V_{DC21} between the corrector 21 and the converter 22 and to receive the voltage setpoint to be applied between the corrector 21 and the converter 22. The microcontroller 30 is able to determine whether each measured value corresponds to the received voltage setpoint to be applied between the corrector 21 and the converter 22.

Moreover, when a measured value does not correspond to the corresponding setpoint value, the microcontroller 30 is configured to update the control signals transmitted to the switches T1, T2, T3, T4, in order to modify the conversion ratio of the converter 22, in order to make the measured voltage, the DC voltage V₁₀ or the DC voltage V_{DC21} correspond to the setpoint.

The microcontroller 30 comprises a processor able to implement a set of instructions allowing these functions to be performed.

### Method:

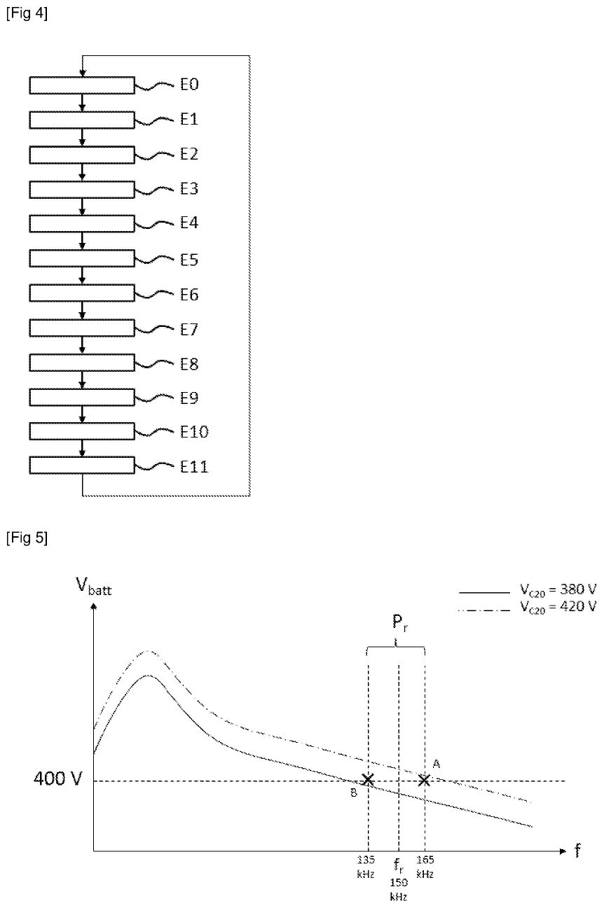

With reference to FIGS. 4 and 5, an embodiment of the method according to the invention, implemented by the microcontroller 30 and the system such as presented above, will now be described.

The example shown in FIG. 5 has a resonant frequency of 150 kHz, a resonant range defined by the following interval [135 KHz; 165 kHz] and an average reference voltage of 400 V.

### First Embodiment

For example, a first embodiment is described in the case where the battery 10 is operating in charging mode, whether the charger 20 is unidirectional or bidirectional.

With reference to FIG. 4, the method first comprises a preliminary step E0 of determining a gain setpoint, in order to allow the battery 10 to be recharged.

The method then comprises a step E1 of controlling the converter 22, in which step the microcontroller 30 transmits a control signal to the switches of the first bridge H1. The frequency of the control signal is determined depending on the gain setpoint and on the voltage across the terminals of the link capacitor C₂₀.

The frequency of the control signal is first set to its highest value, since at the start of charging of the battery 10, said battery 10 is little charged, for example around 300 V, and the gain of the converter 22 is relatively low. Next, the frequency of each control signal is decreased in stages. Specifically, the more the battery 10 is charged, the higher the gain provided by the converter 22 gets and therefore the lower the frequency of the control signal becomes.

The method also comprises a step E2 of comparing the frequency value of the control signal with the resonant range, followed by a step E3 of detecting when the frequency of the control signal is equal to the upper bound of the resonant range (represented by point A in FIG. 5).

Following the detecting step E3, the method comprises a step E4 of controlling the conversion ratio of the power factor corrector 21 so as to decrease the voltage across the terminals of the link capacitor C₂₀, so as to make said voltage equal to 95% of the average operating voltage of said link capacitor C₂₀.

For example, with reference to FIG. 5, the voltage across the terminals of the link capacitor C₂₀ is equal to 380 V and no longer 400 V. The voltage supplied by the converter 22 must increase, to obtain the gain of the gain setpoint.

Therefore, the converter 22 must increase its own gain, which is why it is necessary to decrease the frequency of each control signal (since the frequency of the control signal is inversely proportional to the voltage gain of the converter 22).

The method therefore comprises, simultaneously with the control step E4, a step E5 of setting the frequency of the control signal so that it is lower than the lower bound of the resonant range.

Thus, according to the example shown in FIG. 4, in the setting step E5, the microcontroller 30 modifies the frequency of the control signal from 165 kHz to at most 135 KHz.

The microcontroller 30 may thus use any frequency value lower than the resonant range.

Thus, the frequency of the control signal changes directly from a value higher than the resonant range to a value lower than the resonant range. Thus, the frequency of the control signal avoids the value of the resonant frequency of the converter 22, thus avoiding current oscillations in the electronic components of the charger 20 that could damage said electronic components.

### Second Embodiment

Again for example, a second embodiment of the method will now be described, in the case where the battery 10 is operating in discharging mode to power devices connected to the charger 20 via the corrector 22, the charger 20 therefore being bidirectional.

The method first comprises a preliminary step E6 of determining a gain setpoint in order to allow the devices connected to the charger 20 to be powered by the power supplied by the battery 10.

The method then comprises a step E7 of controlling the converter 22, in which step the microcontroller 40 transmits a control signal to the switches of the second bridge H2. The frequency of the control signal is determined depending on the gain setpoint and on the voltage across the terminals of the link capacitor C₂₀.

The frequency of the control signal is first set to its lowest value. Specifically, the battery 10 is operating in discharging mode, this meaning that the battery 10 is charged to an almost maximum level of charge. Thus, the gain of the converter 22 is relatively high. Next, the frequency of the control signal is increased in stages. Specifically, the more the battery 10 is discharged, the lower the gain provided by the converter 22 gets and therefore the higher the frequency of the control signal becomes.

The method comprises a step E8 of comparing the frequency value of the control signal with the resonant range, followed by a step E9 of detecting when the frequency of the control signal is equal to the lower bound of the resonant range (represented by point B in FIG. 5).

Following the detecting step E9, the method comprises a step E10 of controlling the conversion ratio of the power factor corrector 21 so as to increase the voltage across the terminals of the link capacitor C₂₀, so as to make said voltage equal to 105% of the average operating voltage of said link capacitor C₂₀.

For example, with reference to FIG. 5, the voltage across the terminals of the link capacitor C₂₀ is equal to 420 V and no longer 400 V. The voltage supplied by the converter 22 must decrease, to obtain the gain of the gain setpoint.

Therefore, the converter 22 must decrease its own gain, which is why it is necessary to increase the frequency of each control signal (since the frequency of the control signal is inversely proportional to the voltage gain of the converter 22).

The method therefore comprises, simultaneously with the control step E10, a step E11 of setting the frequency of the control signal so that it is higher than the upper bound of the resonant range.

Thus, according to the example shown in FIG. 5, in the setting step E11, the microcontroller 30 modifies the frequency of the control signal from 135 KHz to at least 165 kHz.

The microcontroller 30 may thus use any frequency value higher than the resonant range.

When the battery 10 is again operating in charging mode, the method returns to the preliminary step E0.

Thus, the frequency of the control signal changes directly from a value lower than the resonant range to a value higher than the resonant range. Thus, the frequency of the control signal avoids the value of the resonant frequency of the converter 22.

1. An electric system for a motor vehicle, the vehicle comprising at least one supply battery, the electric system comprising a microcontroller and an electric charger that is intended to be connected both to said battery and also to an electric grid external to the vehicle supplying an AC voltage, the charger being able to charge the battery from an external electric grid, the charger comprising:
a power factor corrector, which is able to convert an AC voltage into a DC voltage, the conversion being characterized by a conversion ratio, and which is electrically connected to the electric grid,
a DC-DC voltage converter connected between the power factor corrector and the battery and able to convert a DC voltage into another DC voltage, said DC-DC voltage converter comprising a first H-bridge, and a second H-bridge, each H-bridge comprising four switches, a first switch being connected between a high point and a midpoint, a second switch being connected between the midpoint and a low point, a third switch being connected between the high point and a second midpoint and a fourth switch being connected between the second midpoint and the low point, the voltage converter also comprising a transformer electrically connecting the first H-bridge and the second H-bridge,
the converter being characterized by a frequency, referred to as the “resonant” frequency, that is the frequency at which the voltage and current across the terminals of the converter are in phase, and by a resonant range the lower bound of which is 0.9 times the resonant frequency and the upper bound of which is 1.1 times the resonant frequency, and a link capacitor, which is connected between the power factor corrector and the DC-DC voltage converter, and which is able to attenuate residual oscillations in the voltage supplied between the power factor corrector and the DC-DC voltage converter, the link capacitor being characterized by an average operating voltage,
the microcontroller being configured to:
a) control each switch of the first bridge and of the second bridge of the DC-DC voltage converter open and closed by transmitting a control signal to each switch, each control signal being characterized by a frequency,
b) control the conversion ratio of the corrector,
c) when the battery is charging, if the frequency of the control signal is equal to the upper bound of the resonant range:
i) control the conversion ratio of the power factor corrector so as to decrease the voltage across the terminals of the link capacitor, so as to make said voltage equal to 95% of the average operating voltage of said link capacitor,
ii) set the frequency of each control signal so that it is lower than the lower bound of the resonant range.

2. The electric system as claimed in claim 1, wherein the charger is intended to be connected both to said battery and also to devices, the charger being able to allow the battery to power said devices, the converter being bidirectional and the power factor corrector, which is electrically connected to the devices, being able to convert a DC voltage into an AC voltage, the microcontroller being configured to, when the battery is discharging and if the frequency of the control signal is equal to the lower bound of the resonant range:
a) control the conversion ratio of the power factor corrector so as to increase the voltage across the terminals of the link capacitor, so as to make said voltage equal to 105% of the average operating voltage of said link capacitor,
b) set the frequency of each control signal so that the frequency is higher than the upper bound of the resonant range.

3. The electric system as claimed in claim 1, wherein:
a) the transformer of the converter comprises a primary winding and a secondary winding, each winding comprising a first terminal and a second terminal,
b) the converter comprises a first resonant circuit comprising a resonant capacitor and a coil connected in series, the resonant capacitor of the first resonant circuit being electrically connected to the first midpoint of the first bridge, and the coil of the first resonant circuit being electrically connected to the first terminal of the primary winding of the transformer.

4. The electric system as claimed in claim 3, wherein the converter comprises an additional coil, connected in parallel with the primary winding of the transformer.

5. The electric system as claimed in claim 3, wherein the converter comprises a second resonant circuit comprising a resonant capacitor and a coil connected in series, the resonant capacitor of the second resonant circuit being electrically connected to the first midpoint of the second bridge, and the coil of the second resonant circuit being electrically connected to the first terminal of the secondary winding of the transformer.

6. The electric system as claimed in claim 1, wherein each switch is a MOSFET or bipolar transistor.

7. A motor vehicle comprising at least one battery and at least one electric system as claimed in claim 1.

8. A method of controlling the control signal of a motor-vehicle electronic-system converter as claimed in claim 1, when the battery is charging, if the frequency of the control signal is equal to the upper bound of the resonant range, the method comprising steps of:
i) controlling the conversion ratio of the power factor corrector so as to decrease the voltage across the terminals of the link capacitor, so as to make said voltage equal to 95% of the average operating voltage of said link capacitor,
b) setting the frequency of the control signal so that the frequency is lower than the lower bound of the resonant range.

9. A method of controlling the control signal of a motor-vehicle electronic-system converter as claimed in claim 1, when the battery is charging, if the frequency of the control signal is equal to the upper bound of the resonant range, the method comprising steps of:
i) controlling the conversion ratio of the power factor corrector so as to decrease the voltage across the terminals of the link capacitor, so as to make said voltage equal to 95% of the average operating voltage of said link capacitor,
b) setting the frequency of the control signal so that the frequency is lower than the lower bound of the resonant range,
the method being implemented by the electric system
wherein:
a) the transformer of the converter comprises a primary winding and a secondary winding, each winding comprising a first terminal and a second terminal,
b) the converter comprises a first resonant circuit comprising a resonant capacitor and a coil connected in series, the resonant capacitor of the first resonant circuit being electrically connected to the first midpoint of the first bridge, and the coil of the first resonant circuit being electrically connected to the first terminal of the primary winding of the transformer, when the battery is discharging and if the frequency of the control signal is equal to the lower bound of the resonant range, the method comprising steps of:
a) controlling the conversion ratio of the power factor corrector so as to increase the voltage across the terminals of the link capacitor, so as to make said voltage equal to 105% of the average operating voltage of said link capacitor,
b) setting the frequency of the control signal so that it is higher than the upper bound of the resonant range.

10. A non-transitory computer-readable medium on which is stored a set of program-code instructions that, when executed by one or more processors, configure the processor or processors to implement the method of claim 8.

11. The electric system as claimed in claim 2, wherein:
a) the transformer of the converter comprises a primary winding and a secondary winding, each winding comprising a first terminal and a second terminal,
b) the converter comprises a first resonant circuit comprising a resonant capacitor and a coil connected in series, the resonant capacitor of the first resonant circuit being electrically connected to the first midpoint of the first bridge, and the coil of the first resonant circuit being electrically connected to the first terminal of the primary winding of the transformer.

12. The electric system as claimed in claim 11, wherein the converter comprises an additional coil, connected in parallel with the primary winding of the transformer.

13. The electric system as claimed in claim 12, wherein the converter comprises a second resonant circuit comprising a resonant capacitor and a coil connected in series, the resonant capacitor of the second resonant circuit being electrically connected to the first midpoint of the second bridge, and the coil of the second resonant circuit being electrically connected to the first terminal of the secondary winding of the transformer.

14. The electric system as claimed in claim 13, wherein each switch is a MOSFET or bipolar transistor.

15. A motor vehicle comprising at least one battery and at least one electric system as claimed in claim 14.

16. A method of controlling the control signal of a motor-vehicle electronic-system converter as claimed in claim 14, when the battery is charging, if the frequency of the control signal is equal to the upper bound of the resonant range, the method comprising steps of:
i) controlling the conversion ratio of the power factor corrector so as to decrease the voltage across the terminals of the link capacitor, so as to make said voltage equal to 95% of the average operating voltage of said link capacitor,
b) setting the frequency of the control signal so that the frequency is lower than the lower bound of the resonant range.
